(19) United States
(12) Patent Application Publication
(10) Pub. No.: US 2006/0291928 A1
(43) Pub. Date: Dec. 28, 2006

(54) Cleaning unit and electrophotographic image forming apparatus including the same

(75) Inventor: Yong-hoon Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/451,500

(22) Filed: Jun. 13, 2006

(30) Foreign Application Priority Data
Jun. 23, 2005 (KR) 10-2005-0054376

(51) Int. Cl. G03G 21/00

(52) U.S. Cl. 399/350; 399/351

(57) ABSTRACT

A cleaning unit and an electrophotographic image forming apparatus including the cleaning unit that prevents a cleaning blade from overturning is disclosed. The cleaning unit includes a cleaning blade that contacts an outer circumference of an object to be cleaned with a predetermined pressure, and thus removes material remaining on the outer circumference of the object while the object is rotating. A bracket is connected to one side of the cleaning blade and supports the cleaning blade. A support frame is connected to the other side of the cleaning blade (that is, a side opposite to the side where the bracket is connected), and is placed close to the object to be clean. The support frame prevents the cleaning blade from being bent in a rotation direction of the object.

### CROSS-REFERENCE TO RELATED PATENT APPLICATIONS

This application claims the benefit under 35 U.S.C. § 119(a) of Korean Patent Application No. 10-2005-0054376, filed on Jun. 23, 2005, in the Korean Intellectual Property Office, the entire disclosure of which is hereby incorporated by reference.

### BACKGROUND OF THE INVENTION

1. Field of the Invention

The present invention generally relates to a cleaning unit and an electrophotographic image forming apparatus including the cleaning unit. More particularly, the present invention relates to a cleaning unit with a blade that withstands environmental variations, and an image forming apparatus including the same.

2. Description of the Related Art

In general, an electrographic image forming apparatus such as a laser printer, a fax machine, or a digital copier, produces an image by forming an electrostatic latent image by scanning light onto a photosensitive medium charged to a predetermined electrostatic potential. Then, the latent image is developed by providing a developing device, for example, toner, to the latent image to form a toner image, and the toner image on the photosensitive medium is transferred and fused to a sheet of paper. To obtain a sharp and clear image, the electrophotographic image forming apparatus includes a cleaning unit that removes waste toner from the photosensitive medium when the toner is not transferred from the photosensitive medium to the paper and remains on the photosensitive medium.

FIG. 1 shows a cleaning unit 10 according to the prior art.

Referring to FIG. 1, the cleaning unit 10 includes a cleaning blade 11 and a bracket 12 that is connected to the cleaning blade 11 to support the cleaning blade 11. An end of the cleaning blade 11 contacts an outer circumference of a photosensitive medium 1, and extends in a direction opposite to the rotating direction of the photosensitive medium 1. If the cleaning blade 11 contacts the photosensitive medium 1 while the photosensitive medium 1 is rotating, friction is generated between the photosensitive medium 1 and the cleaning blade 11 and waste toner W remaining on the outer circumference is scraped and removed from the outer circumference. The cleaning blade 11 may be made of urethane rubber or urethane elastomer, which are elastic materials and a surface of the cleaning blade 11 can be processed so that it is soft.

However, the cleaning blade 11 made of the urethane material is vulnerable to environmental variations. In particular, the urethane material softens at high temperature and high humidity levels, and thus loses its elasticity. Consequently, the area where the cleaning blade 11 contacts the photosensitive medium 1, that is, a friction area, increases due to the weak elasticity. As a result, the friction between the cleaning blade 11 and the photosensitive medium 1 is increased, and hence, the cleaning blade 11 can be turned over in the direction of rotation of the photosensitive medium 1 as shown with the dotted line in FIG. 1. In this event, since the waste toner W cannot be totally removed from the photosensitive medium 1, it is difficult to produce good image quality.

Accordingly, there is a need for an improved cleaning device for an image forming apparatus, and an image forming apparatus using the same.

### SUMMARY OF THE INVENTION

An aspect of the present invention is to address at least the above problems and/or disadvantages and to provide at least the advantages described below. Accordingly, an aspect of the present invention is to provide a cleaning unit capable of preventing a cleaning blade from turning over due to environmental variations such as high temperature and high humidity and an electrophotographic image forming apparatus including the cleaning unit.

According to an aspect of the present invention, a cleaning unit comprises a bracket, a cleaning blade supported by the bracket, and a support frame. The cleaning blade contacts an outer perimeter of an object to be cleaned with a predetermined pressure, and thus removes material remaining on the outer perimeter of the object while the object is rotating. The support frame is connected to the side of the cleaning blade which is opposite to the side where the bracket is connected, and is placed close to the object being cleaned. The support frame prevents the cleaning blade from being bent in a rotation direction of the object.

According to another aspect of the present invention, an electrophotographic image forming apparatus comprises a photosensitive medium on which an electrostatic latent image is formed, a developing device for producing a visible image by supplying toner to the latent image, a transfer roller for transferring the visible image to a sheet of paper, and a cleaning unit for removing waste toner remaining on an outer perimeter of the photosensitive medium. The cleaning unit comprises a bracket, a cleaning blade supported by the bracket, and a support frame. The cleaning blade contacts an outer perimeter of an object to be cleaned with a predetermined pressure, and thus removes material remaining on the outer perimeter of the object while the object is rotating. The support frame is connected to the side of the cleaning blade which is opposite to the side where the bracket is connected, and is placed close to the object being cleaned. The support frame prevents the cleaning blade from being bent in a rotation direction of the object.

The cleaning blade may include a constrained portion connected to the bracket and a free portion that extends from the constrained portion to the object and contacts the outer perimeter of the object while pressing the outer perimeter. The support frame may extend over the constrained portion and the free portion of the cleaning blade, be connected to the constrained portion and separated from the free portion, and a portion of the support frame over the free portion may act as an overturn preventing portion.

The length of the overturn preventing portion of the support frame may be shorter than the length of the free portion of the cleaning blade and shorter than the length from an end of the free portion of the cleaning blade to an end of the overturn preventing portion.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a cross-sectional view of a conventional cleaning unit;

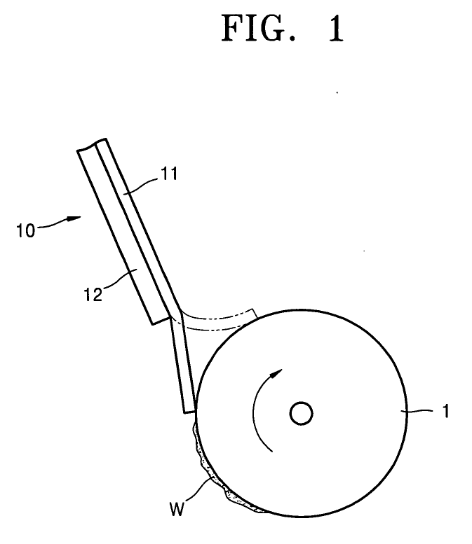

FIG. 2 is a schematic, cross-sectional view of a structure of an electrophotographic image forming apparatus according to an exemplary embodiment of the present invention;

FIG. 3 is a cross-sectional view of the cleaning unit of the electrophotographic image forming apparatus illustrated in FIG. 2;

FIG. 4 is an exploded perspective view of the cleaning unit illustrated in FIG. 3; and

FIG. 5 is a cross-sectional view of the cleaning unit illustrated in FIG. 3.

Throughout the drawings, the same reference numerals will be understood to refer to the same elements, features, and structures.

### DETAILED DESCRIPTION OF THE INVENTION

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

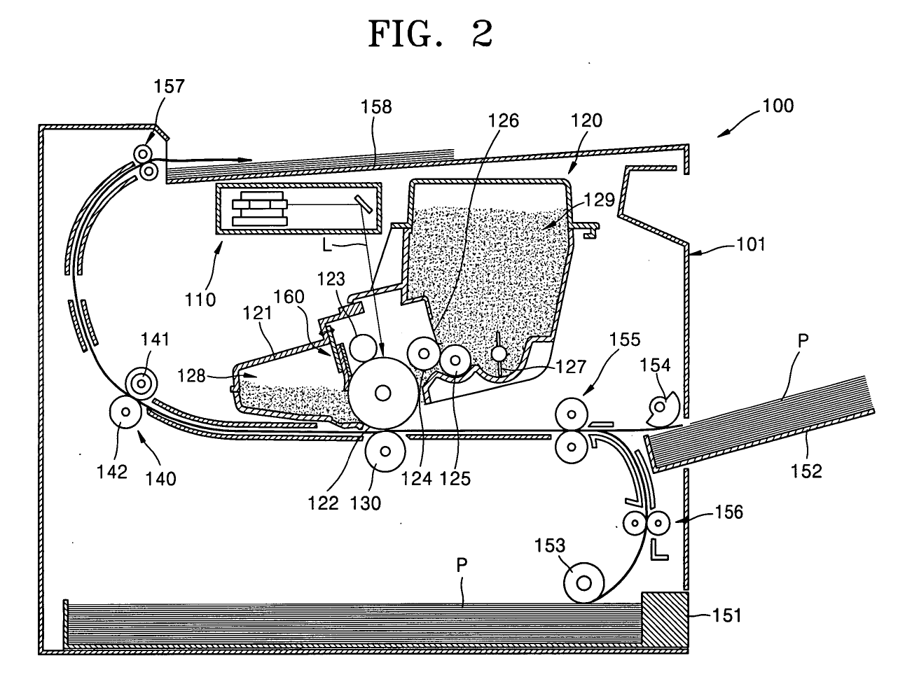

FIG. 2 is a cross-sectional view of an electrophotographic image forming apparatus 100 according to an exemplary embodiment of the present invention. Referring to FIG. 2, the electrophotographic image forming apparatus 100 includes a cabinet 101, a scanning unit 110 included in the cabinet 101, a developing device 120, a transfer roller 130, a fuser 140, and a cleaning unit 160.

The scanning unit 110 forms an electrostatic latent image by scanning light L corresponding to image data onto a photosensitive medium 122, which will be described in detail later. The scanning unit 110 may be a laser scanning unit (LSU) that uses a laser diode as a light source.

The developing device 120 includes a housing 121. The photosensitive medium 122, a charging roller 123, a developing roller 124, a supply roller 125, a doctor blade 126, and an agitator 127 are installed in the housing 121. Further, in the housing 121 of the developing device 120, a waste toner containing space 128 for storing waste toner removed from an outer circumference of the photosensitive medium 122 and a toner containing space 129 for storing the toner provided to the photosensitive medium 122 are formed. The toner is, for example, a solid powder-type toner. The developing device 120 may be a cartridge type device which is detachably installed in the cabinet 101.

A photoconductive material is disposed on the outer circumference of the photosensitive medium 122. The photoconductive material may be disposed on the medium by deposition. The photosensitive medium 122 is installed such that a part of its outer circumference is exposed, and rotates in a predetermined direction. An electrostatic latent image corresponding to a desired image is formed on the outer circumference of the photosensitive medium 122 by charging the photosensitive medium to a predetermined electrostatic potential with the charging roller 123 and scanning the charged photosensitive medium with light L irradiated by the scanning unit 110. A charging bias voltage is applied to the charging roller 123 so that the outer circumference of the photosensitive medium 122 is charged to a uniform electrostatic potential. A corona charger may be used instead of the charging roller 123.

The developing roller 124 develops a visible image by providing toner that is adhered to the latent image formed on the photosensitive medium 122. A developing bias voltage is applied to the developing roller 124 to provide the toner to the photosensitive medium 122. The supply roller 125 provides the toner to the outer circumference of the developing roller 124. The doctor blade 126 regulates the thickness of the toner which has been provided by the supply roller 125. The agitator 127 stirs the toner in the toner containing space 129 so that the toner does not harden. The developing device 120 includes the cleaning unit 160 according to an exemplary embodiment of the present invention, which is installed on the photosensitive medium 122. A detailed description of the cleaning unit 160 will be provided later.

The transfer roller 130 is installed to face the outer circumference of the photosensitive medium 122. A transfer bias voltage of a polarity opposite to that of the visible image is applied to the transfer roller 130 such that the visible image formed on the outer circumference of the photosensitive medium 122 can be transferred to a sheet of paper P. Due to the transfer bias voltage, or a contact pressure between the transfer roller 130 and the photosensitive medium 122, the visible image developed on the outer circumference of the photosensitive medium 122 is transferred to the paper passing between the photosensitive medium 122 and the transfer roller 130.

The fuser 140 includes a heat roller 141 and a pressure roller 142 installed opposite to the heat roller 141. The heat roller 141 and the pressure roller 142 apply, respectively, heat and pressure to the paper P between the heat roller 141 and the pressure roller 142 to fix the visible image to the paper P. Consequently, when the paper to which the visible image has been transferred passes between the heat roller 141 and the pressure roller 142, the visible image is fused to the paper P by heat and pressure.

A first feeding cassette 151 and a second feeding cassette 152 containing sheets of paper S are installed in a bottom portion of the cabinet 101 of the electrophotographic image forming apparatus 100. A first pickup roller 153 and a second pickup roller 154 are installed in the first and second feeding cassettes 151 and 152, respectively, and the first and second pickup rollers 153 and 154 pick up the paper P one by one. A paper aligner 155 is provided to align the paper P discharged by the first or second pickup roller 153 or 154 before the paper P passes between the photosensitive medium 122 and the transfer roller 130, and a conveying roller 156 is installed to convey the paper P from the first pickup roller 153 toward the paper aligner 155. Further, a discharging roller 157 is installed to discharge the paper P on which the visible image has been fused by the fuser 140 to a discharge tray 158 outside the cabinet 101.

The operation of the electrophotographic image forming apparatus with the above structure is as follows. The photosensitive medium 122 forms an electrostatic latent image corresponding to a desired image on its outer circumference after being charged to a predetermined electrostatic potential by the charging roller 123 and exposed to light scanned by the scanning unit 110. When the toner contained in the toner containing space 129 of the developing device 120 is supplied to the photosensitive medium 122, on which the latent image has been formed, by the supply roller 125 and the developing roller, the visible image is developed on the outer circumference of the photosensitive medium 122. The paper P passes between the photosensitive medium 122 and the transfer roller 130 after being picked up from the first feeding cassette 151 or the second feeding cassette 152 and then aligned by the paper aligner 155. As the paper passes between the photosensitive medium 122 and the transfer roller 130, the visible image developed on the photosensitive medium 122 is transferred to a surface of the paper P which faces the photosensitive medium 122. The visible image transferred to the paper P is fused by the heat and pressure applied by the fuser 140 and is completely printed on the paper P. The paper P on which the visible image has been printed is conveyed by the discharging roller 157 and stacked in the discharge tray 158.

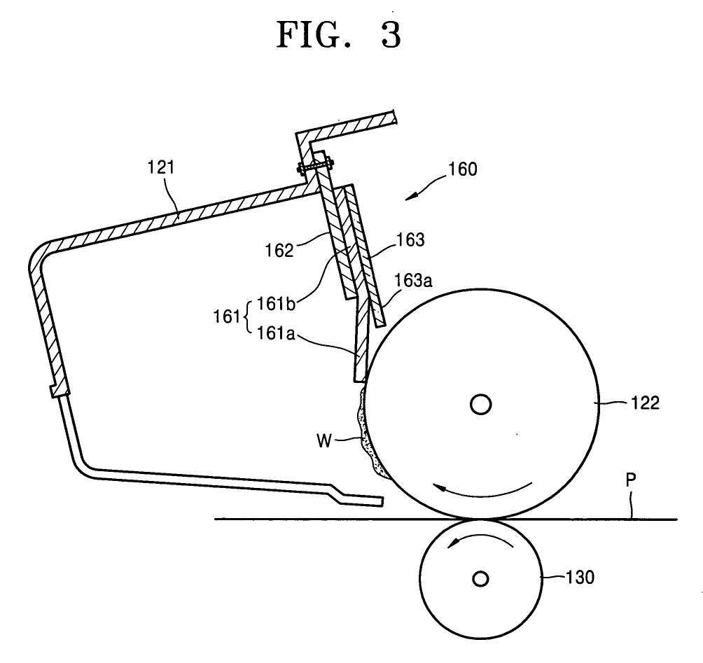

After printing is performed according to the above operation, waste toner W that has not been transferred to the paper P remains on the outer circumference of the photosensitive medium 122. If the waste toner W is not removed, it can affect successive printing. That is, due to the remaining waste toner W, a good quality image cannot be produced in successive printing. Therefore, the cleaning unit 160 is installed on the photosensitive medium 122 to remove the waste toner W remaining on the outer circumference of the photosensitive medium 122. The cleaning unit 160 should maintain its cleaning performance under different environmental conditions, particularly, at high temperature and high humidity levels, such that a good quality image can be continuously produced. To this end, the cleaning unit 160 has a structure as shown in FIGS. 3 through 5.

The cleaning unit 160 shown in FIG. 3 includes a cleaning blade 161. The cleaning blade 161 contacts the outer circumference of the photosensitive medium 122 while applying a predetermined pressure to the outer circumference. Specifically, a portion of the cleaning blade 161 toward the outer circumference of the photosensitive medium 122 is elastically bent in a direction opposite to the rotation direction of the photosensitive medium 122. In this condition, an end of the portion of the cleaning blade 161 can contact the outer circumference of the photosensitive medium 122. The elastically bent portion of the cleaning blade 161 presses the outer circumference of the photosensitive medium 122 due to its restoring force, and the end of the portion is placed toward the direction opposite to the rotation direction of the photosensitive medium 122. When the photosensitive medium 122 rotates, friction is generated in the contacting area between the cleaning blade 161 and the photosensitive medium 122, thereby removing the waste toner W remaining on the outer circumference of the photosensitive medium 122

The cleaning blade 161 is made of urethane rubber or urethane elastomer, which are elastic materials, and the surface of the cleaning blade 161 can be processed to be soft. The urethane rubber or urethane elastomer is produced by adding a catalyst and other additives to a compound containing two or more active hydrogen atoms and a compound containing two or more reactive isocyanate groups, and mixing and hardening them. In this case, the compound containing two or more active hydrogen atoms may be a polyol, for example, a polyether polyol, a polyester polyol, or a polyetherester polyol, or a denatured polyol such as an acryl denatured polyol, and a silicon denatured polyol. The compound containing two or more reactive isocyanate groups may be a poly isocyanate, for example, toluene diisocyanate (TDI), 4,4-methylene diphenyl diisocyanate (MDI), a compound of TDI and MDI, a denatured TDI, or a denatured MDI.

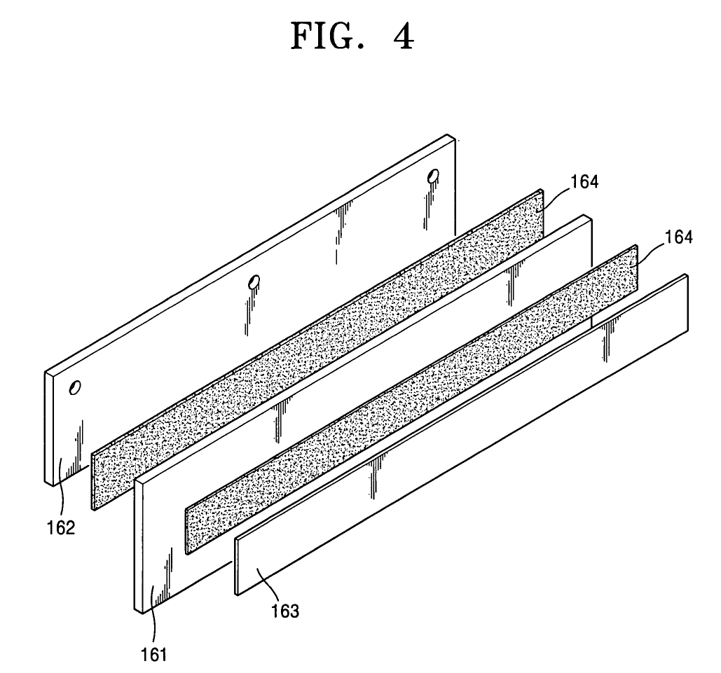

The cleaning blade 161 has a plate shape as shown in. FIG. 4. The plate-shaped cleaning blade 161 contacts the outer surface of the photosensitive medium 122 along the longitudinal direction of the photosensitive medium 122, and thus can scrape the waste toner W. The thickness of the cleaning blade 161 may be between 0.1 mm and 5 mm. When the thickness of the cleaning blade 161 is below 0.1 mm, the cleaning blade 161 may be too elastic to perform cleaning, and when the thickness is over 5 mm, the cleaning blade 161 may be so rigid that the size or weight of a member supporting the cleaning blade 161, that is, a bracket 162 or a support frame 163, which will be described below, becomes unnecessarily large.

The bracket 162 is installed on a first side of the cleaning blade 161, ahead of the support frame 163 toward the rotation direction of the photosensitive medium 122. As shown in FIG. 4, the bracket 162 has a plate shape, is connected to the cleaning unit 161 such that the end of the bracket 162 is placed at a predetermined distance above the end of the cleaning blade 161 toward the photosensitive medium 122, and supports the cleaning blade 161. Accordingly, a portion of the cleaning blade 161 where the bracket 3 is not connected and extended toward the photosensitive medium 122 is a movable free portion 161a, and the other portion where the bracket is connected is a constrained portion 161b whose movement is restricted. The free portion 161a extends from the constrained portion 161b, and hence can be elastically bent in a direction opposite to the rotation direction of the photosensitive medium 122 to contact the photosensitive medium 122. If the free portion 161a is too long, the friction between the photosensitive medium and the free portion 161a becomes weak, and if the free portion 161a is too short, the friction becomes excessively large. Therefore, the cleaning blade 161 should have a length appropriate for sufficiently removing the waste toner W from the photosensitive medium 122. Since the movement of the constrained portion 161b is restricted by the bracket 162, the cleaning blade 161 is not pushed in a direction opposite to the rotation direction of the photosensitive medium 122 and can be supported by the bracket 162.

To adequately support the constrained portion 161b, the bracket 162 may be made of a metal material, such as iron, aluminum, copper, an iron alloy, and a copper alloy, or a plastic material having a high hardness. Further, the thickness of the bracket 162 may be between 0.1 mm and 5 mm. If the thickness of the bracket 162 is below 0.1 mm, the cleaning performance may be reduced since the bracket 162 cannot support a force applied to the cleaning blade 161 during cleaning, and if the thickness is over 5 mm, the weight of the bracket 162 may be too much, and thus the image forming apparatus 100 becomes heavier and excessive material is used.

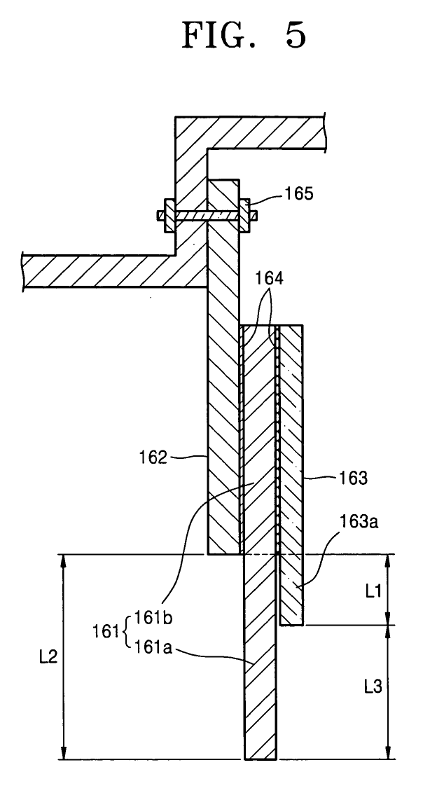

The bracket 162 and the cleaning blade 161 may be connected to each other using an adhesive member 164 such as double-sided tape as shown in FIGS. 4 and 5, or using a connection member such as a screw. A portion of the bracket 162 connected to the cleaning blade 161, which extends in a direction opposite to the photosensitive medium 122, is connected and fixed to the housing 121. Preferably, the bracket 162 is connected to the housing 121 instead of connecting the cleaning blade 161 directly to the housing 121 because the bracket 162 can be more tightly fixed to the housing 121 than the cleaning blade 161. The bracket 162 may be connected to the housing 121 using a connection member 165 such as a screw or a rivet.

The support frame 163 is connected to a second side of the cleaning blade. That is, the support frame 163 is connected to the opposite side of the cleaning blade 161 to which the bracket 162 is connected. The support frame 163 prevents the free portion 161 a of the cleaning blade 161 from being bent in the rotation direction of the photosensitive medium 122. To this end, the support frame 163 has a plate shape and extends over the constrained portion 161b and the free portion 161a of the cleaning blade 161 as shown in FIG. 4. A portion of the support frame 163, which covers the constrained portion 161b of the cleaning blade 161, is connected to the constrained portion 161b. The support frame 163 and the cleaning blade 161 may be connected to each other using an adhesive member 164 such as double-sided tape as shown in FIGS. 4 and 5, or using a connection member such as a screw. A portion 163a of the support frame 163 above the free portion 161a of the cleaning blade 161 is disconnected from the free portion 161a that prevents the free portion 161a from being turned over. The portion 163a of the support frame 163 is, for example, placed as close to the photosensitive medium 122 as possible, but if the portion 163a is too long, the portion 163a may contact and damage the outer circumference of the photosensitive medium 122. Thus, the length L1 of the portion 163a may be shorter than the length L2 of the free portion 161a of the cleaning blade 161. Moreover, the length L1 of the portion 163a may be shorter than the length L3 from the end of the portion 163a to the end of the free portion 161a of the cleaning blade 161.

The support frame 163 may be made of a metal material such as iron, aluminum, copper, an iron alloy, and copper alloy, or a plastic material having a high hardness. Further, the thickness of support frame 163 may be between 0.1 mm and 3 mm. If the thickness of the support frame 163 is below 0.1 mm, the support frame 163 may not properly prevent the cleaning blade 161 from being turned over, and if the thickness is over 3 mm, the weight of the support frame 163 causes the image forming apparatus 100 to become heavier and excessive material is used. Additionally, when the support frame 163 is too thick, the support frame 163 can contact the photosensitive medium 122, thus damaging the photosensitive medium 122.

As described above, the cleaning unit 160 according to the present exemplary embodiment has a simple structure and can prevent the free portion 161a of the cleaning blade 161 from being turned over in the rotation direction of the photosensitive medium 122, even when the elastic force of the cleaning blade 161 made of an urethane material is weak due to an environmental change, such as a high temperature and high humidity, which reduces the friction between the cleaning blade 161 and the photosensitive medium 122. Furthermore, the cleaning unit 160 can address the problem of a low quality image and output interruption due to a turned over cleaning blade 161.

The above advantages are illustrated in Tables 1 and 2.

Table 1 and Table 2 show the experimental results of comparing a cleaning unit according to the present invention with a conventional cleaning unit. Table 1 shows the results when one sheet and three sheets of papers are alternately printed at intervals of 12 seconds at a printing speed of 33 ppm, and Table 2 shows the results when papers are successively printed at a printing speed of 33 ppm. The cleaning unit used in the experiment employed a cleaning blade with a width of 223 mm, a length of 15 mm and a thickness of 2 mm, and the length of the free portion was 9 mm. The width of the support frame was 223 mm, the length was 10 mm and the thickness was 0.5 mm, and the support frame was made of stainless steel. The conventional cleaning unit did not include a support frame. Each of the cleaning units was installed in a developing device and performed printing at a temperature of 32° C. and relative humidity of 80%.

TABLE 1

| | Cleaning unit according to | |
|---|---|---|
| Number of | the present exemplary | |
| printed sheets | embodiment | Conventional cleaning unit |
| 5,000 | No defective image | No defective image |
| 10,000 | No defective image | No defective image |
| 15,000 | No defective image | No defective image |
| 20,000 | No defective image | Cleaning blade turned over |
| 25,000 | No defective image | Printout impossible |

Referring to Table 1, the results of alternately printing show that in the cleaning unit according to the exemplary embodiments of the present invention, the cleaning blade was not turned over at all and there were no print errors. In the conventional cleaning unit, the cleaning blade turned over when the number of printed sheets was over 20,000 and printing was impossible when the number of printed sheets was over 25,000.

TABLE 2

| | Cleaning unit according to | |
|---|---|---|
| Number of | the present exemplary | |
| printed sheets | embodiment | Conventional cleaning unit |
| 5,000 | No defective image | No defective image |
| 10,000 | No defective image | Cleaning blade turned over |
| 15,000 | No defective image | Printout impossible |
| 20,000 | No defective image | Printout impossible |
| 25,000 | No defective image | Printout impossible |

Referring to Table 2, the results of successively printing at a printing speed of 33 ppm at high temperature and high humidity show that in the cleaning unit of the exemplary embodiments of the present invention, the cleaning blade was not turned over at all and there were no print errors. In the conventional cleaning unit, the cleaning unit was turned over when the number of printed sheets was over 10,000 and printing was impossible when the number of printed sheets was over 25,000. That is, compared with Table 1, Table 2 shows that in successive printing, the conventional cleaning unit starts to malfunction earlier than in interval printing.

The cleaning unit according to exemplary embodiments of the present invention as described above cleans the photosensitive medium, but can also be used for an intermediate transfer belt or an intermediate transfer roller which is included in a monotone or color electrophotographic image forming apparatus.

According to the exemplary embodiments of the present invention described above, a cleaning unit with a simple structure can prevent a cleaning blade from being turned over due to environmental variations, such as high temperature and high humidity. Accordingly, the performance of the cleaning blade is maintained, and thus better image quality can be produced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A cleaning unit comprising:
a cleaning blade for contacting an outer circumference of an object to be cleaned and for removing a material remaining on the outer perimeter of the object while the object is rotating;
a bracket disposed on one side of the cleaning blade for supporting the cleaning blade;
a support frame disposed on a side of the cleaning blade opposite to the side where the bracket is disposed, the support frame being disposed adjacent to the object to be cleaned, the support frame preventing the cleaning blade from being bent in a rotation direction of the object.

2. The cleaning unit of claim 1, wherein the cleaning blade comprises a constrained portion connected to the bracket and a free portion that extends from the constrained portion and contacts the outer perimeter of the object.

3. The cleaning unit of claim 2, wherein the support frame extends over the constrained portion and the free portion of the cleaning blade, and is connected to the constrained portion and separated from the free portion, and a portion of the support frame over the free portion acts as an overturn preventing portion for preventing the free portion from being bent in a rotation direction of the object.

4. The cleaning unit of claim 3, wherein the length of the overturn preventing portion of the support frame is shorter than the length of the free portion of the cleaning blade.

5. The cleaning unit of claim 4, wherein the length of the overturn preventing portion of the support frame is shorter than the length from an end of the free portion of the cleaning blade to an end of the overturn preventing portion.

6. The cleaning unit of claim 5, wherein the free portion of the cleaning blade that contacts the outer circumference of the object to be cleaned is bent in a direction opposite to the rotation direction of the object.

7. The cleaning unit of claim 6, wherein the free portion of the cleaning blade is disposed toward a direction opposite to the rotation direction of the object.

8. The cleaning unit of claim 1, wherein the bracket is placed ahead of the support frame toward the rotation direction of the object.

9. The cleaning unit of claim 1, wherein the cleaning blade comprises at least one of urethane rubber and urethane elastomer.

10. The cleaning unit of claim 9, wherein the at least one of urethane rubber and urethane elastomer is made by adding a catalyst and other additives to a compound containing two or more active hydrogen atoms and a compound containing two or more reactive isocyanate groups.

11. The cleaning unit of claim 10, wherein the compound containing two or more active hydrogen atoms is a polyol and the compound containing two or more reactive isocyanate groups is a poly isocyanate.

12. The cleaning unit of claim 9, wherein the thickness of the cleaning blade is between 0.1 mm and 5 mm.

13. The cleaning unit of claim 1, wherein the support frame comprises at least one of iron, aluminum, copper, an iron alloy, an aluminum alloy, a copper alloy, and a plastic.

14. The cleaning unit of claim 13, wherein the thickness of the support frame is between 0.1 mm and 3 mm.

15. The cleaning unit of claim 1, wherein the bracket comprises at least one of iron, aluminum, copper, an iron alloy, an aluminum alloy, a copper alloy, and plastic.

16. The cleaning unit of claim 15, wherein the thickness of the bracket is between 0.1 mm and 5 mm.

17. The cleaning unit of claim 1, wherein the object to be cleaned comprises at least one of a photosensitive medium, an intermediate transfer belt, and an intermediate transfer roller.

18. An electrophotographic image forming apparatus comprising:
a photosensitive medium on which an electrostatic latent image is formed;
a developing device for producing a visible image by supplying toner to the electrostatic latent image;
a transfer roller for transferring the visible image to a sheet of paper; and
a cleaning unit for removing waste toner remaining on an outer circumference of the photosensitive medium, the cleaning unit comprising a cleaning blade contacting an outer perimeter of the photosensitive medium, a bracket for supporting the cleaning blade, and a support frame installed on the cleaning blade and disposed adjacent to the photosensitive medium to prevent the cleaning blade from being bent in a rotation direction of the photosensitive medium.

19. The electrophotographic image forming apparatus of claim 18, wherein the cleaning blade comprises a constrained portion connected to the bracket and a free portion that extends from the constrained portion and contacts the outer perimeter of the photosensitive medium, the support frame extending over the constrained portion and the free portion of the cleaning blade, the support frame being connected to the constrained portion and separated from the free portion, and a portion of the support frame over the free portion acting as an overturn preventing portion for preventing the free portion from being bent in a rotation direction of the object.

20. The electrophotographic image forming apparatus of claim 19, wherein the length of the overturn preventing portion of the support frame is shorter than the length of the cleaning blade and the length from an end of the free portion of the cleaning blade to an end of the overturn preventing portion.
